(19) United States
(12) Patent Application Publication
(10) Pub. No.: US 2010/0118755 A1
(43) Pub. Date: May 13, 2010

(54) CONTROL APPARATUS, SIGNAL TRANSMISSION METHOD AND COMPUTER PROGRAM PRODUCT FOR THE CONTROL APPARATUS

(75) Inventors: Wei-Chih LIN, Keelung City (TW); Po-Wen CHI, Taipei (TW); Yu-Hsiang LIN, Taoyuan County (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: INSTITUTE FOR INFORMATION INDUSTRY, Taipei (TW)

(21) Appl. No.: 12/353,498

(22) Filed: Jan. 14, 2009

(30) Foreign Application Priority Data
Nov. 10, 2008 (TW) 097143394

(51) Int. Cl. H04H 20/71

(52) U.S. Cl. 370/312

(57) ABSTRACT

A control apparatus, a signal transmission method and a computer program product for the control apparatus are provided. The control apparatus, which is for use in a wireless network comprising at least one mobile station (MS), comprises a storage module, a receiving module, and a determination module. The storage module is configured to store a multicast group list. The receiving module is configured to receive an idle mode entry signal which comprises information of the at least one MS. The determination determines whether the multicast group list has the information of the at least one MS. If the multicast group list does not have the information of the at least one MS, the determination module adds the information of the at least one MS into the multicast group list.

This application claims the benefit of priority based on Taiwan Patent Application No. 097143394, filed on Nov. 10, 2008, the contents of which are incorporated herein by reference in their entirety.

### CROSS-REFERENCES TO RELATED APPLICATIONS

Not applicable.

### BACKGROUND OF THE INVENTION

1. Field of the Invention

The present invention relates to a control apparatus, a signal transmission method and a computer program product for the control apparatus. More particularly, the present invention relates to a control apparatus capable of directly transmitting an Internet Group Management Protocol (IGMP) report, a signal transmission method and a computer program product for the control apparatus.

2. Descriptions of the Related Art

With the advancement of science and technology and the development of the IT industry, computers and networks have become indispensable to everyday life. For example, people have been accustomed to processing various data using the Internet on computers to search for information, shop and exchange data. Over recent years, wireless networks, which eliminate the need of physical network wiring and feature high mobility, have been set up. For example, the Worldwide Interoperability for Microwave Access (WiMAX) wireless network, which is currently experiencing the most rapid development, has already been able to support wireless Internet connection under high-speed mobile conditions and further support voice service.

In a wireless network, mobile phones or notebook type computers may be viewed as mobile apparatuses or mobile stations. When attempting to access a particular service (i.e., to browse a webpage) from the wireless network, the mobile station sends a request for establishing a wireless connection to the target webpage to the corresponding base station. Because data transmission between the mobile station and the base station does not occur continuously during webpage browsing, the mobile station may enter into an idle mode to save power when data transmission is not going on therebetween.

In addition, because the population of network users has rapidly increased, the usage of network bandwidth and addresses has also significantly increased. To solve this problem, wireless network service providers and wireless network equipment manufacturers have proposed the concept of “multicast”, which is intended to reduce the usage of the network bandwidth. For example, when a plurality of users connected to different base stations are attempting to access CTV (China Television Company) program data via the wireless network, the solution of the prior art transmits the CTV program data through unicast to each of the base stations through a one-to-one correspondence, which then forwards the data to each of the users respectively. However, with the multicast method, users who attempt to access the CTV program data via the wireless network will be viewed as a single group, of which members belonging to the same group are all allowed to receive data representing the group network address. Then, the CTV program data may be transmitted to the users through the multicast at the same time. Thus, through multicast, data can be transmitted to a plurality of users at the same time, resulting in a substantial decrease in the usage of the network bandwidth and addresses.

To deploy a wireless network provided with both a multicast function and an idle mode, an IGMP framework needs to be incorporated in the wireless network to provide the multicast function. FIG. 1 illustrates a wireless network 1 incorporating the IGMP framework, which comprises a multicast system 11 and a plurality of mobile stations 13, 15, 17, 19. The multicast system 11 is configured to store a multicast group list, which lists multicast groups currently existing in the wireless network 1. For example, if there are two kinds of data that are being transmitted in the wireless network, such as the CTV program data (not shown) and CTS (China Television System) program data (not shown), the two multicast groups will be recorded in the multicast group list. That is, one of the multicast groups is set to an Internet Protocol (IP) address that transmits the CTV program data, while the other is set to another IP address that transmits the CTS program data.

According to the multicast group list, the multicast system 11 periodically broadcasts an IGMP query signal 110 incorporating the IP address that transmits the CTV program data and an IGMP query signal 112 incorporating the IP address that transmits the CTS program data. Upon receiving the IGMP query signal 110 and the IGMP query signal 112, each of the mobile stations 13, 15, 17, 19 determines which multicast group it belongs to according to the IP addresses incorporated in the IGMP query signal 110 and the IGMP query signal 112. More specifically, if the mobile stations 13, 15 only desire to receive the CTV program data, they may join the multicast group corresponding to the CTV program; on the other hand, if the mobile station 17 only desires to receive the CTS program data, it may join the multicast group corresponding to the CTS program. Furthermore, if the mobile station 19 desire to receive both the CTV program data and the CTS program data, it may join both multicast groups corresponding to the CTV and CTS programs.

When the mobile stations 13, 15, 17, 19 receive the IGMP query signal 110 and the IGMP query signal 112 respectively, the mobile stations 13, 15 return an IGMP report signal 130 and an IGMP report signal 150 respectively in response to the IGMP query signal 110 to inform the multicast system 11 that they still need to receive the CTV program data. The mobile station 17 then returns an IGMP report signal 170 in response to the IGMP query signal 112 to inform the multicast system 11 that it still needs to receive the CTS program data. The mobile station 19 then returns an IGMP report signal 190 and an IGMP report signal 192 in response to the IGMP query signal 110 and the IGMP query signal 120 respectively to inform the multicast system 11 that it still needs to receive both the CTV program data and the CTS program data. In this way, the multicast system 11 of the wireless network 1 is able to accomplish the multicast function successfully.

After receiving an IGMP query signal from the multicast system 11, each of the mobile stations in the wireless network 1 must return an IGMP signal to the multicast system 11. If the mobile station in the idle mode receives an IGMP query signal, it must exit the idle mode through a large amount of control signals and re-establish the data channel to return an IGMP report signal. If there is no additional data needed after returning the IGMP report signal, the mobile station will enter the idle mode once again through a large amount of control signals and delete the data channel. Therefore, in the case where the multicast system 11 transmits IGMP query signals periodically, the mobile station has to enter and exit the idle mode frequently. Consequently, the transmission of a large amount of control signals required for the mobile station to exit and enter the idle mode causes unnecessary waste of the wireless network bandwidth, and frequently entering/exiting the idle mode also leads to a substantial increase in the power consumption of the mobile station.

FIG. 2 illustrates a schematic view of signal transmission between the multicast system 11 and the mobile station 17. The multicast system 11 comprises a base station 111, an access network service (ASN) gateway 113, a paging controller (PC) 115 and an authenticator 117. When the mobile station 17 is in the idle mode, this means that it is unable to transmit or receive a signal except receiving a multicast signal but. The multicast group list of the multicast system 11 is stored in the ASN gateway 113. Upon receiving the IGMP query signals 110, 112 transmitted by the ASN gateway 113 via the base station 11, the mobile station 17 must exit the idle mode first and reestablish the data channel to return an IGMP report signal 170 to the ASN gateway 113 in response to the IGMP query signal 112.

Accordingly, the mobile station 17 first transmits a correction request signal 210 to the base station 111 which, in response to the correction request signal 210, transmits an idle mode exiting request signal 230 to inform the ASN gateway 113 that the mobile station 17 is going to exit the idle mode. Meanwhile, the ASN gateway 113 forwards the idle mode exiting request signal 230 to the paging controller 115. In response to the idle mode exiting request signal 230, a context exchange procedure 290 for the mobile station 17 is executed between the paging controller 115 and the authenticator 117.

When the execution of the context exchange procedure 290 between the paging controller 115 and the authenticator 117 is completed, the paging controller 115 transmits an idle mode exiting response signal 270 to the ASN gateway 113 which then forwards the idle mode exiting response signal 270 to the base station 111. Upon receiving the idle mode exiting response signal 270, the base station 111 transmits a channel registration request signal 232 to the ASN gateway 113 and then receives a channel registration response signal 250 from the ASN gateway 113 to re-establish a data channel for the mobile station 17. Once the data channel is established for the mobile station 17, the base station 111 transmits a correction response signal 234 to the mobile station 17 immediately so that the mobile station 17 will exit the idle mode. Thereafter, the mobile station 17 transmits an IGMP report signal 170 to the ASN 113 via the base station 111. As a result, after receiving the IGMP query signals 110, 112, the mobile station 17 exits the idle mode and returns the IGMP signal 170 to the ASN gateway 113.

To reduce bandwidth waste in the wireless network and power consumption of the mobile stations, two solutions of the prior art have been proposed. According to one of the solutions, each mobile station in the wireless network 1 has a delay-to-transmit time for transmitting the IGMP report signal to prevent simultaneous transmission of IGMP report signals from all mobile stations in a same group after receiving the IGMP query signals, which would otherwise cause traffic congestion and bandwidth waste in the wireless network. According to the other solution, once a single mobile station transmits an IGMP report signal in broadcast, the other mobile stations belonging to the same group will not need to transmit the respective IGMP report signal, thereby decreasing the number of control signal and the power consumption of the mobile stations that would otherwise increase due to the frequent exiting from idle mode.

The following example will be illustrated using mobile stations 13, 15, 19 that belong to the CTV program group in the wireless network 1. Assuming that the mobile station 13 has a delay-to-transmit time of 1 second (s), the mobile station 15 has a delay-to-transmit time of 2 s while the mobile station 19 has a delay-to-transmit time of 3 s. After the mobile stations 13, 15, 19 receive the IGMP query signal 110 respectively, the mobile station 13 which has a delay-to-transmit time of 1 s broadcasts an IGMP report signal 130 first. Once the mobile stations 15, 19 receive the IGMP report signal 130, it will be unnecessary for them to transmit their respective IGMP report signals 150 and 190, thus reducing the probability for the mobile stations 15, 19 to exit the idle mode. However, this practice still fails to reduce the probability for the mobile station 13 to exit the idle mode.

In summary, when the multicast system 11 transmits IGMP query signals periodically, the mobile stations still have to enter and exit the idle mode frequently, which causes unnecessary bandwidth waste in the wireless network and substantial increase in power consumption of the mobile stations. Accordingly, it is important to provide, in a wireless network provided with both the multicast function and the idle mode, a solution that may prevent the mobile station from frequently exiting the idle mode to return an IGMP report signal after periodically receiving an IGMP query signal.

### SUMMARY OF THE INVENTION

The objective of this invention is to provide a control apparatus, a signal transmission method and a computer program product for the control apparatus. The control apparatus is used in a wireless network comprising a gateway system and at least one mobile station. The control apparatus is configured to receive a multicast query signal corresponding to a multicast group of the at least one mobile station, and respond to a multicast report signal immediately in a multicast so that after receiving the multicast query signal, the at least one mobile station still remains in the idle mode instead of exiting idle mode to respond with a multicast report signal.

To this end, the control apparatus of this invention comprises a storage module, a receiving module and a determination module. The storage module is configured to store a multicast group list. The receiving module is configured to receive an idle mode entry signal, which comprises information of the at least one mobile station previously described. The determination module is configured to determine whether the multicast group list has the information of the at least one mobile station. If the multicast group list does not have the information of the at least one mobile station, the determination module adds the information of the at least one mobile station into the multicast group list.

The signal transmission method for the control apparatus of this invention comprises the following steps: receiving an idle mode entry signal, wherein the idle mode entry signal comprises information of the at least one mobile station; determining if the multicast group list has information of the at least one mobile station. If the multicast group list does not have the information of the at least one mobile station, then the information of the at least one mobile station is added into the multicast group list.

This invention also provides a computer program product stored in a computer readable medium for the control apparatus to perform the signal transmission method.

In summary, the control apparatus of this invention adds information from a multicast group with at least one mobile station into a multicast group list thereof and, after receiving a multicast query signal corresponding to the multicast group of the at least one mobile station, responds with a multicast report signal immediately in a multicast. As a result, after receiving the multicast query signal, the at least one mobile station may still remain in the idle mode instead of responding with a multicast report signal. This is effective to prevent the mobile station from overly frequently exiting/entering the idle mode to return the multicast report signal, which would otherwise cause increased power consumption of the mobile station and bandwidth waste in the wireless network.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a wireless network of the prior art that has an IGMP framework;

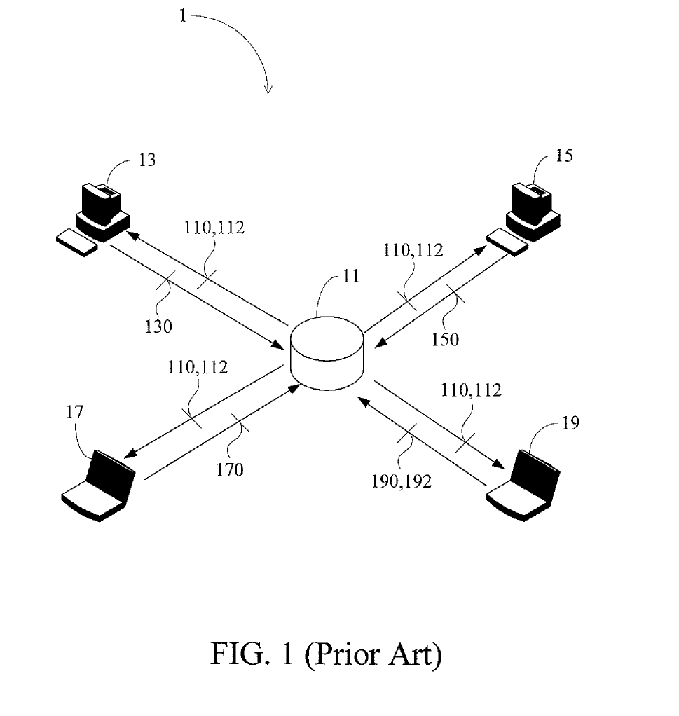

FIG. 2 is a schematic view illustrating signal transmission in the wireless network of the prior art that has an IGMP framework;

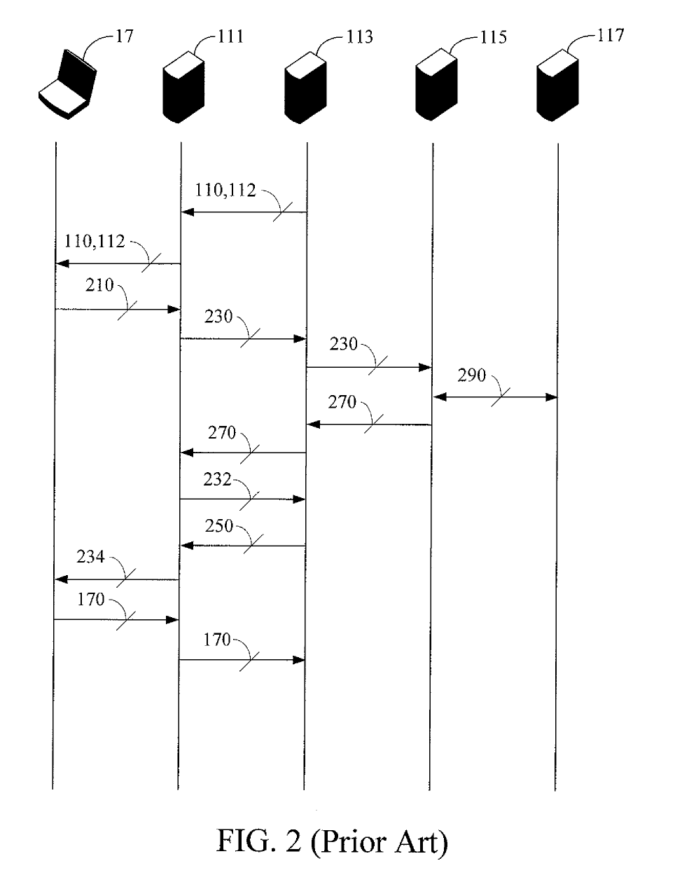

FIG. 3 is a schematic view of a wireless network according to a first embodiment of this invention;

FIG. 4 is a schematic view of a control apparatus according to the first embodiment; and

FIG. 5 is a flowchart of a second embodiment of this invention.

### DESCRIPTION OF THE PREFERRED EMBODIMENT

In the following description, this invention will be explained with reference to embodiments thereof. However, the description of these embodiments is only for purposes of illustration rather than limitations. It should be appreciated that in the following embodiments and the attached drawings, the elements not related directly to this invention are omitted from depiction and dimensional relationships among individual elements in the attached drawings are illustrated only for ease of understanding, and not limitation.

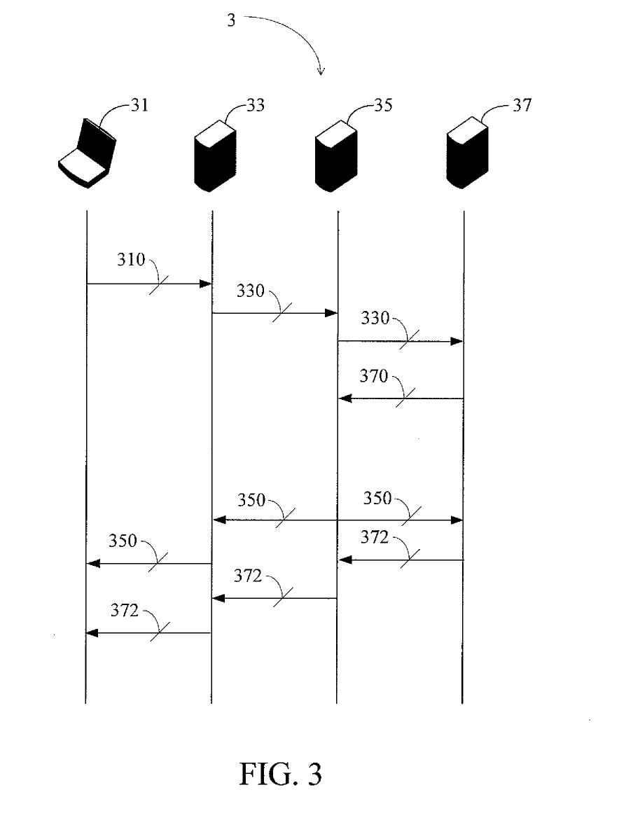

A first embodiment of this invention is depicted in FIG. 3, which is a schematic view illustrating the signal transmission in a wireless network 3 with an IGMP framework. The wireless network 3 comprises at least one mobile station 31, a gateway system 33, 35 and a control apparatus 37. In this embodiment, the wireless network 3 is a wireless network conforming to the IEEE. 802.16e standard. The control apparatus 37 is a paging controller conforming to the IEEE. 802.16e standard. The gateway system 33, 35 comprises a base station 33 and an ASN gateway 35. In this embodiment, for purpose of simplicity, only one mobile station 31 is depicted in the wireless network 3. However, in other embodiments, the wireless network 3 may comprise any number of mobile stations instead of being limited to the single mobile station 31 illustrated in this embodiment.

In the wireless network 3, when the mobile station 31 is going to enter the idle mode, it transmits a correction request signal 310 to the base station 33. From the correction request signal 310, the base station 33 is formed that the mobile station 31 is going to enter the idle mode. Subsequently, in response to the correction request signal 310, the base station 33 generates and transmits an idle mode entry signal 330 to the ASN gateway 35 which further forwards the idle mode entry signal 330 to the control apparatus 37, so that the control apparatus 37 is informed that the mobile station 31 is going to enter the idle mode.

Upon receiving the idle mode entry signal 330, the control apparatus 37 determines whether it has joined a multicast group corresponding to the mobile station 31 or not. If not, it generates and transmits a joining request signal 370 to the ASN gateway 35 in response to the idle mode entry signal 330, so that the control apparatus 37 can join the multicast group corresponding to the mobile station 31. Then, when the ASN gateway 35 multicasts a multicast query signal 350, the multicast query signal 350 will be received by the mobile station 31 via the base station 33 and also by the control apparatus 37.

While the mobile station 31 is still in the idle mode, the control apparatus 37, in response to the multicast query signal 350, broadcasts a multicast report signal 372 immediately without any waiting. The ASN gateway 35, the base station 33 and the mobile station 31 will all receive the multicast report signal 372. Upon receiving the multicast report signal 372, the mobile station 31 cancels the operation of returning a multicast report signal to the ASN gateway 35s. As a result, the mobile station 31 needs not exit the idle mode to return the multicast query signal 350 while the ASN gateway 35 can still receive the multicast report signal 372. In the following descriptions, the method in which the control apparatus 37 generates and transmits the multicast report signal 372 corresponding to the mobile station 31 in response to the idle mode entry signal 330 will be described in detail.

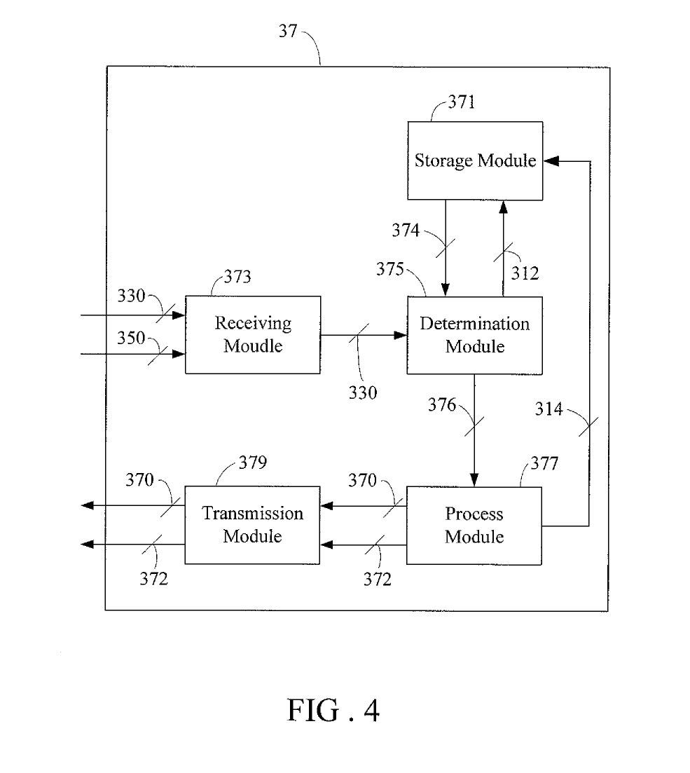

FIG. 4 is a schematic view of the control apparatus 37. The control apparatus 37 comprises a storage module 371, a receiving module 373, a determination module 375, a processing module 377 and a transmission module 379. The storage module 371 is configured to store a multicast group list 374. The receiving module 373 is configured to receive the idle mode entry signal 330 which incorporates the information of the mobile station 31, i.e., the multicast group 314 to which the mobile station 31 belongs and the address information 312 of the mobile station 31. The ASN gateway 35 of the gateway system at least has a multicast group corresponding to the information of the mobile station 31. The determination module 375 is configured according to both the multicast group list 374 and the information of the mobile station 31 incorporated in the idle mode entry signal 330 to determine (1) if the multicast group list 374 includes the multicast group 314 corresponding to the mobile station 31 and (2) if the multicast group list 374 includes the address information 312 corresponding to the mobile station 31.

If the multicast group list 374 does not include the multicast group 314 corresponding to the mobile station 31 and the address information 312 corresponding to the mobile station 31, the determination module 375 generates a determination result 376 to the processing module 377 which, in response to the determination result 376, creates a multicast group 314 in the multicast group list 374. Then, the determination module 375 adds the address information 312 corresponding to the mobile station 31 into the multicast group 314 in the multicast group list 374.

For example, the multicast group list 374 stored in the storage module 371 may include two multicast groups; namely, a multicast group that receives the TTV (Taiwan Television) program data and a multicast group that receives the CTV program data with the mobile station 31 belonging to the multicast group 314 that receives the CTS program data. Accordingly, the determination module 375 determines that the multicast group list 374 does not include the multicast group 314 corresponding to the CTS program data according to the multicast group list 374 and the information of the mobile station 31. Then, the processing module 377 creates the multicast group 314 corresponding to CTS in the multicast group list 374, while the determination module 375 adds the address information 312 of the mobile station 31 into the multicast group 314 corresponding to CTS in the multicast group list 374.

After the address information 312 of the mobile station 31 is added into the multicast group in the storage module 371 and in response to the idle mode entry signal 330, the processing module 377 enables the transmission module 379 to transmit the joining request signal 370 to the ASN gateway 35 to join the multicast group corresponding to the information of the mobile station 31. For example, if the address information 312 of the mobile station 31 is added into the multicast group 314 corresponding to the CTS program in the multicast group list 374, the control apparatus 37 will be added into this multicast group 314 corresponding to the CTS program.

If the determination module 375 determines that the multicast group list 374 already includes the multicast group 314 corresponding to the mobile station 31 but the multicast group 314 has not included the address information 312 corresponding to the mobile station 31 yet, the determination module 375 adds the address information 312 corresponding to the mobile station 31 into the multicast group 314 in the multicast group list 374 directly.

More specifically, the multicast group list 374 stored in the storage module 371 already includes two multicast groups; namely, a multicast group that receives the TTV program data and a multicast group that receives the CTS program data. Because the mobile station 31 belongs to the multicast group 314 that receives the CTS program data, the determination module 375 determines that the multicast group list 374 already includes the multicast group 314 corresponding to the CTS program data in which the mobile station 31 can join according to the multicast group list 374 and the information of the mobile station 31. Accordingly, the determination module 375 adds the address information 312 of the mobile station 31 into the multicast group 314 corresponding to the CTS in the multicast group list 374 directly.

After the above operations are completed, if the receiving module 373 of the control apparatus 37 receives a multicast query signal 350, the processing module 377 enables the transmission module 379 to broadcast a multicast report signal 372 to the mobile station 31, the ASN gateway 35 and the base station 33 immediately in response to the multicast query signal 350. Upon receiving the multicast report signal 372, the mobile station 31 ceases the procedure of transmitting a multicast report signal immediately to prevent the exiting from the idle mode.

In other words, because the control apparatus 37 can transmit a multicast report signal instead of the mobile station 31, a mobile station in the idle mode needs not exit the idle mode to return the multicast report signal when it receives a multicast query signal. In this Way, this invention is effective in preventing the mobile station from overly frequently exiting/entering the idle mode to transmit the multicast report signal, which would otherwise cause an increased power consumption of the mobile station and bandwidth waste in the wireless network.

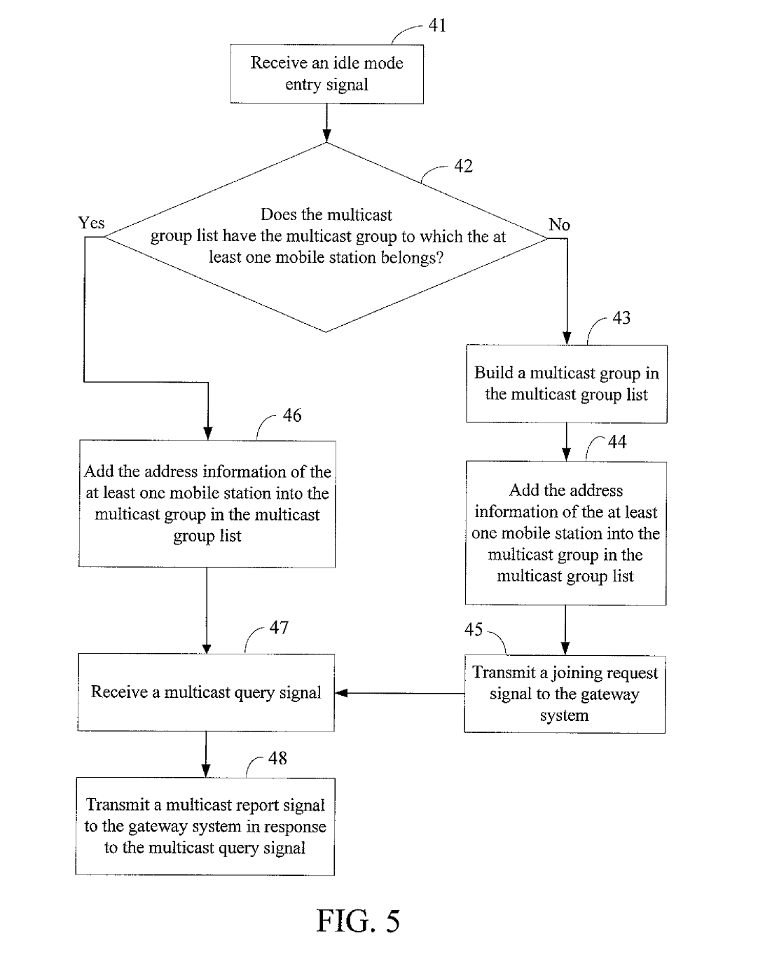

FIG. 5 depicts a second embodiment of this invention, which is a signal transmission method. The signal transmission method is adapted for a control apparatus, e.g., the control apparatus 37 described in the first embodiment. The control apparatus 37 is for use in a wireless network comprising a gateway system and at least one mobile station. The control apparatus is configured to store a multicast group list. More specifically, the signal transmission method described in the second embodiment may be executed by a computer program product. When the computer program product is loaded into the control apparatus 37 via a computer and a plurality of program instructions embodied thereon is executed, the signal transmission method of the second embodiment can be accomplished. This computer program product may be stored in a tangible machine-readable medium, such as an ROM, a flash memory, a floppy disk, a hard disk, a compact disk, a mobile disk, a magnetic tape, a database accessible to networks, or any other storage media with the same function and well known to those skilled in the art.

The signal transmission method of the second embodiment comprises the following steps. Initially, in Step 41, an idle mode entry signal is received. The idle mode entry signal comprises information of the at least one mobile station, which in turn comprises a multicast group to which the at least one mobile station belongs and the address information. Then, in Step 42, it is determined whether the multicast group list has the multicast group to which the at least one mobile station belongs. If not, a multicast group is built in the multicast group list in Step 43. Next, in Step 44, the address information of the at least one mobile station is added into the multicast group created in Step 43. Subsequently, a joining request signal is transmitted to the gateway system in Step 45 to join the multicast group corresponding to the information of the at least one mobile station.

If it is determined in Step 42 that the multicast group list has already included the multicast group to which the at least one mobile station belongs, the process proceeds directly to Step 46 where the address information of the at least one mobile station is added into the multicast group list which the at least one mobile station belongs to the multicast group.

Subsequent to the above steps, a multicast query signal is received in Step 47. Finally in Step 48, the control apparatus transmits a multicast report signal to the gateway system in response to the multicast query signal if the multicast groups to be queried belong to the multicast group list.

In summary, the control apparatus of this invention can transmit a multicast report signal instead of the mobile station. Therefore, the mobile station in the idle mode needs not exit the idle mode to return a multicast report signal when it receives a multicast query signal. In this way, this invention is effective in preventing the mobile station from overly frequently exiting/entering the idle mode to transmit the multicast report signal, which would otherwise cause increased power consumption of the mobile station and bandwidth waste in the wireless network.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A control apparatus for use in a wireless network comprising a gateway system and at least one mobile station, the control apparatus comprising:
a storage module, being configured to store a multicast group list;
a receiving module, being configured to receive an idle mode entry signal, wherein the idle mode entry signal comprises information of the at least one mobile station; and
a determination module, being configured to determine whether the multicast group list has information of the at least one mobile station;
wherein when the multicast group list does not have the information of the at least one mobile station, the determination module adds the information of the at least one mobile station into the multicast group list.

2. The control apparatus as claimed in claim 1, further comprising a processing module, wherein if the multicast group list does not have the information of the at least one mobile station, the processing module builds a multicast group in the multicast group list, and the information of the at least one mobile station is added into the multicast group in the multicast group list via the determination module.

3. The control apparatus as claimed in claim 2, wherein the control apparatus further comprises a transmission module being configured to transmit a joining request signal to the gateway system, so that the control apparatus joins in the multicast group corresponding to the information of the at least one mobile station.

4. The control apparatus as claimed in claim 1, wherein the multicast group list has a multicast group, and the information of the at least one mobile station is added into the multicast group in the multicast group list via the determination module.

5. The control apparatus as claimed in claim 1, further comprising a transmission module, wherein the receiving module is configured to receive a multicast query signal, the transmission module is configured to transmit a multicast report signal to the gateway system in response to the multicast query signal, and the multicast report signal responds for the multicast groups in the multicast group list.

6. The control apparatus as claimed in claim 1, wherein the wireless network is a wireless network conforming to the IEEE 802.16e standard, and the control apparatus is a paging controller conforming to the IEEE 802.16e standard.

7. A signal transmission method for use in a control apparatus, the control apparatus being for use in a wireless network comprising a gateway system and at least one mobile station, the control apparatus storing a multicast group list, the signal transmission method comprising following steps of:
receiving an idle mode entry signal, wherein the idle mode entry signal comprises information of the at least one mobile station;
determining whether the multicast group list has information of the at least one mobile station; and
adding the information of the at least one mobile station into the multicast group list when the multicast group list does not have the information of the at least one mobile station.

8. The signal transmission method as claimed in claim 7, wherein the step of adding the information of the at least one mobile station into the multicast group list further comprises the steps of:
building a multicast group in the multicast group list; and
adding the information of the at least one mobile station into the multicast group in the multicast group list.

9. The signal transmission method as claimed in claim 8, further comprising a step of:
transmitting a joining request signal to the gateway system to join in the multicast group corresponding to the information of the at least one mobile station.

10. The signal transmission method as claimed in claim 7, wherein the multicast group list has a multicast group, and the step of adding the information of the at least one mobile station into the multicast group list further comprises a step of:
adding the information of the at least one mobile station into the multicast group in the multicast group list.

11. The signal transmission method as claimed in claim 7, further comprising the steps of:
receiving a multicast query signal; and
transmitting a multicast report signal to the gateway system in response to the multicast query signal, wherein the multicast report signal responds for the multicast groups in the multicast group list.

12. A computer program product stored in a computer readable medium for a control apparatus to perform a signal transmission method, the control apparatus being for use in a wireless network comprising a gateway system and at least one mobile station, the control apparatus storing a multicast group list, the computer program product comprising:
a program instruction A for a receiving module to receive an idle mode entry signal, wherein the idle mode entry signal comprises information of the at least one mobile station;
a program instruction B for a determination module to determine whether the multicast group list has information of the at least one mobile station; and
a program instruction C for the determination module to add the information of the at least one mobile station into the multicast group list when the multicast group list does not have the information of the at least one mobile station.

13. The computer program product as claimed in claim 12, wherein the third program instruction further comprises:
a program instruction C1 for a processing module to build a multicast group in the multicast group list; and
a program instruction C2 for the determination module to add the information of the at least one mobile station into the multicast group in the multicast group list.

14. The computer program product as claimed in claim 13, further comprising:
a program instruction D for a transmission module to transmit a joining request signal to the gateway system to join in the multicast group corresponding to the information of the at least one mobile station.

15. The computer program product as claimed in claim 12, wherein the multicast group list has a multicast group, and the third program instruction further comprises:
a program instruction C1 for the determination module to add the information of the at least one mobile station into the multicast group in the multicast group list.

16. The computer program product as claimed in claim 12, further comprising:
a program instruction D for the receiving module to receive a multicast query signal; and
a program instruction E for the transmission module to transmit a multicast report signal to the gateway system in response to the multicast query signal, wherein the multicast report signal responds for the multicast groups in the multicast group list.
